(19) United States
(12) Patent Application Publication
(10) Pub. No.: US 2024/0326228 A1
(43) Pub. Date: Oct. 3, 2024

(54) PROCESSING IMPLEMENT

(71) Applicant: MTD PRODUCTS INC., Valley City, OH (US)

(72) Inventors: Stefan SAUER, Saarbrucken (DE); Kai Uwe FINK, Saarbrucken (DE); Patrick Christian SCHMIDT, Saarbrucken (DE); Markus ANDORF, Saarbrucken (DE); Ingo KUBIK, St. Wendel (DE)

(21) Appl. No.: 18/737,109

(22) Filed: Jun. 7, 2024

Related U.S. Application Data
(63) Continuation of application No. PCT/EP2022/084323, filed on Dec. 3, 2022.

(30) Foreign Application Priority Data
Dec. 8, 2021 (DE) 102021132352.5

(51) Int. Cl. B25G 3/02; A01B 1/02; A01D 7/00; A01G 3/025; A01G 3/033; A01G 3/047; A01G 3/053; A01G 3/06; A01G 3/08; B25G 1/04

(52) U.S. Cl. CPC B25G 3/02; B25G 1/04; A01B 1/02; A01D 7/00; A01G 3/0255; A01G 3/0335; A01G 3/0475; A01G 3/053; A01G 3/062; A01G 3/067; A01G 3/086

(57) ABSTRACT

A processing device (10), in particular a gardening and/or household implement, comprising a handling device (20) with a gripping portion (30) and a connecting portion (40), and further comprising an electrical power supply (45) and a tool (50) which can be detachably connected to the handling device (20) by means of the connecting portion (40), wherein the tool (50) is an electrical or non-electrical tool and the connecting portion (40) has means by which both the electrical and alternatively the non-electrical tool (50) can be connected to the handling device (20), and to a handling device (20) and a connecting portion (40) for such an implement and use thereof.

### CROSS-REFERENCE TO RELATED APPLICATIONS

The present application is a continuation of international application PCT/EP2022/084323 filed on Dec. 3, 2022, which claims priority under 35 U.S.C. § 119 to German Application Serial No. 102021132352.5 filed on Dec. 8, 2021, which is herein incorporated by reference in its entirety.

### BACKGROUND OF THE INVENTION

### Field of the Invention

The invention relates to a processing device, in particular a gardening and/or household device, and to a handling device, and further to a connecting portion, and to a use of such a connecting portion.

### Description of the Related Art

Processing implements or devices, such as gardening and/or household implements or devices, with a wide variety of functions have been known for some time. Until now, it was usually necessary to use a separate processing implement, or implement, for each of these different functions in order to carry out a task. This meant that a whole range of different implements had to be kept on hand in order to use them alternately, depending on the application. Moreover, some of these implements are electrical, but others are non-electrical.

The problem that existed in the past of having to keep, sometimes, a large number of implements on hand for different tasks in order to carry out the various tasks was solved in the past by trying to use parts of the implement, such as a necessary handle, not only for one implement, but to modify them in such a way that different tools could be connected to this handle. In this way, only different tools had to be kept on hand, but they could all be connected to a specific handle.

One problem that could not be solved in this way in the past and that still exists, however, is the fact that, as mentioned above, some electrical implements and some non-electrical implements were used to perform different tasks. In the past, it was not possible to connect electrical implements to a non-electrical handle and to connect a non-electrical implement to an electrical handle, and therefore, due to these incompatibilities it was still necessary to have several tool handles on hand in the past. This meant that these prior art processing implements still required a lot of space for their storage when they were not needed. Furthermore, it was still disadvantageous that different handling devices, such as handles, were necessary for the use of implements that did not require a power supply and for implements that did require a power supply, which in turn led to high costs and also to the fact that it always had to be remembered to also carry the various handles and tools that were compatible with each other.

The invention is thus based on the problem of providing a processing implement that avoids the above-mentioned disadvantages and can be used universally for tasks that require both non-electrical and electrical tools.

### SUMMARY OF THE INVENTION

According to one aspect, there in provided a processing device, in particular a gardening and/or household device, which comprises a handling device with a handle portion and a connecting portion, as well as an electrical power supply and a tool which can be detachably connected to the handling device by means of the connecting portion, wherein the tool is an electrical or non-electrical tool and the connecting portion has means with which both the electrical and alternatively the non-electrical tool can be connected to the handling device.

For this purpose, the connecting portion has common, or identically usable, means for the mechanical and, if applicable, electrical connection of the particular electrical or non-electrical tool to the handling device.

The processing device comprises a handling device which, in addition to a handle portion, comprises a connecting portion which in turn comprises means for both mechanical and electrical connection of a particular tool to the handling device.

In this way, it is possible to connect both non-electrical tools and electrical tools to the same means of the handling device without having to use different handling devices or different handles. The processing devices has, in its connecting portion which serves to connect to a tool, means which allow a purely mechanical connection of the tool to the handling device, but at the same time, namely whenever this is required, also an electrical connection of the tool to the handling device.

The handling device also has an electrical power supply, for the purpose of supplying power to electrically operating tools, which is used to operate the electrically operating tools connected to the handling device.

According to one embodiment, the connecting portion is in the form of a socket, wherein the means for mechanically and electrically connecting the tool to the handling device are arranged within the socket.

In this case, the socket represents an end portion of the handling device that is distal from the handle portion of the handling device, and a plug-in pin of the tool and also, if applicable, electrical contacts of the tool can be inserted into said end portion and firmly connected to the handling device.

According to a another embodiment, the connecting portion for mechanically connecting the tool to the handling device has detachable form-fit and/or frictional engagement means, for example in the form of at least one plug-in and/or clamping and/or screw and/or detent and/or snap-fit connection with a, preferably non-circular, guide, in order to insert a plug-in pin of the tool as well as its electrical contacts into the connecting portion and to detachably lock them there, preferably in an end position.

The mechanical connection can be embodied as a plug connection and, if appropriate, also as a screw connection, for example as a bayonet connection, which is locked or fixed, as appropriate, by means of a clamping, detent and/or snap-fit mechanism or also a clamping screw or a union sleeve, wherein the plug-in pin is held, for example, in a latching manner in an undercut or by means of a union sleeve or union nut or is retained by means of a clamping screw in any groove or on its surface.

The connecting portion for electrically connecting the tool to the handling device may further comprises at least two, preferably at least three, four or, as required, more electrical contacts, for example in the form of plug sockets and/or contact surfaces, which establish a contact, in particular an electrically conductive contact, with the corresponding contacts, in particular plugs and/or contact surfaces, of the tool.

According to a another embodiment, the means for mechanically and electrically connecting the tool to the handling device are arranged relative to each other in such a way that, in an end or latching position, i.e. a locking position, of the mechanical connection, an electrical connection of the various plug sockets and/or contact surfaces with the corresponding plugs and/or contact surfaces of the tool assigned to them is ensured.

The processing device thus has numerous advantages over the previously known prior art. Thus, it is possible in a simple manner to connect a wide variety of tools, whether electrical or non-electrical, to one and the same handling device, specifically both in the form of a stable, mechanical, play-free and easily detachable connection by providing a plug connection which is reliably secured in its end position or, more generally locking position, by a detent and/or snap-fit device. By means of this detent and/or snap-fit device, the plug-in pin of the tool inserted into the socket of the connecting portion is securely fixed in the socket, or in the connecting portion in its end position, wherein the tool, or its plug-in pin, can only be removed again from the connecting portion if the detent and/or snap-fit device is deliberately detached and the plug-in pin of the tool is detached again in this way. Furthermore, the fixing of the plug-in pin or another part of the electrical or non-electrical tool inserted into the socket of the connecting portion can be realised by means of a clamping, for example by means of at least one clamping screw or by means of a union sleeve/union nut.

The plug connection may have a guide which is, preferably, non-circular, i.e. is formed in such a way that the plug-in pin of the tool, which in turn has a shape corresponding to the non-circular guide, is only inserted into the socket of the connecting portion in a manner predefined by the shape of the guide and is locked there in a precisely predefined position, it can be reliably ensured that the tool, on the one hand, is always connected to this handling device with its correct orientation with respect to the handling device and a faulty connection of the tool to the handling device is thus excluded.

Furthermore, the plug connection, which can also be referred to as a quick coupling or click connection due to its simple design, allows a very quick connection of a tool to the handling device and removal of the tool from the handling device and thus a quick tool change.

The electrical contacting of the tool with the relevant corresponding electrical contacts in the distally arranged connecting portion of the handling device, i.e. in the socket of the connecting portion, may be performed in the course of establishing the mechanical connection of the tool to the handling device and so the electrical contacting is carried out simultaneously or quasi-simultaneously with the mechanical connection and locking, wherein the mechanical locking of the plug-in pin of the tool in a position, preferably end position, of the plug-in pin simultaneously ensures that the electrical contacting is also ensured and the electrical contacts of the tool are in electrically conductive connection to the electrical contacts of the handling device, i.e. the electrical contacts arranged in the connecting portion of the handling device.

The guide and securing means provides a stable, secure and play-free mechanical connection between the tool and the handling device and is formed in such a way that this guide simultaneously leads to the secure and accurately fitting contacting of the relevant electrical contacts of the tool with the corresponding electrical contacts of the handling device and secures this electrical contacting of the tool with the handling device for the duration of the use of the tool on the handling device.

For this purpose, the plug-in pin of the tool is first inserted into the guide of the socket of the connecting portion, wherein, due to the non-circular embodiment of the guide, the plug-in pin is oriented in the socket during the insertion of the plug-in pin into the socket, so that the electrical contacts of the tool are also brought into an exact position for contacting the contacts of the handling device. The electrical contacts of the tool may be arranged in a fixed position with respect to the plug-in pin. The same applies also to the electrical contacts of the handling device, which are arranged in a corresponding fixed position with respect to the guide and the detent and/or snap-fit device for fixing the plug-in pin in its locking position.

When a non-electrical tool is connected to the handling device, only the mechanical plug-in/detent and/or snap-fit connection comes into play, whereas the electrical plug sockets are not occupied. In this case, it is possible that the electrical plug sockets remain open to the outside; alternatively, however, a non-electrical tool can also comprise a cover plate which covers the electrical plug sockets to the outside. According to a further alternative, it is also conceivable that plastic plugs are inserted into the various electrical plug sockets instead of electrically conductive plugs, thus protecting the plug sockets from contamination and substantially closing them off from the outside.

The electrical connection of the handling device may be used both for the electrical connection of an electrically operated tool and for the connection of a charger for charging the electrical power supply of the handling device. Such charging of the electrical power supply of the handling device via the electrical contacts provided in the connecting portion has the advantage that no further connection options for charging the electrical power supply of the handling device need to be provided on the handling device, this applying both to the handle portion, or a handle of the handling device, and to the connecting portion of the handling device, as well as to any handle extension of the handling device.

According to an embodiment, the handling device comprises, between the handle portion and the connecting portion, an extension means, for example in the form of a tube extension or a shaft, which is in particular telescopic and optionally reversibly detachable from the handle portion and/or the connecting portion.

Such an embodiment of the processing device is advantageous because objects at a greater distance can also be processed by means of a processing device embodied in this way. In this way, it is possible, for example, to saw off branches of a tree from a greater distance by means of a sawing tool or to cut them off by means of pruning shears. It is advantageous here if the extension means is telescopic, as this allows the length of the processing implement to be adapted to the desired purpose or to the height of an operator.

The extension means is preferably formed as a tube extension, for example in the form of a shaft, which has at least one cavity that can accommodate, for example, a power supply, a control unit and, if necessary, electrical or mechanical cables.

Accordingly, the electrical power supply in the form of preferably at least one battery, advantageously a rechargeable battery, is arranged preferably in the extension means, optionally removably.

According to a further embodiment, the socket of the connecting portion and/or its guide and/or the plug sockets of the electrical contact points of the connecting portion has/have in each case at least one sealing lip and/or at least one scraper.

The use of such a sealing lip or such a scraper, preferably at the distal entrance of the socket of the connecting portion and/or its guide and/or at the distal entrances of the plug sockets of the electrical contact points of the connecting portion is advantageous in moist and/or dusty environments, since the various sealing lips and/or scrapers, which can be made of rubber or in the form of a miniature brush, for example, offer a certain degree of protection against moisture on the one hand, but can also wipe off any impurities on the plug-in pin and/or the electrical contact plugs of the tool and in this way prevent the corresponding sockets of the connecting portion from becoming contaminated.

Furthermore, the guide of the connecting portion can be formed as a sleeve. Such a sleeve guides the plug-in pin of the tool closely and without play when it is inserted into the connecting portion. Such a sleeve may be embodied in such a way that it either presses the guide closely against the plug-in pin or fits closely against the plug-in pin and/or the guide, so that the plug-in pin can be pushed into its end position with virtually no, or little or a small amount of play. The sleeve and/or the guide, for this purpose, can be made of a material on which the plug-in pin can slide, for example polytetrafluoroethylene.

Furthermore, the sleeve can be substantially annular and can enclose the plug-in pin at its proximal end, so that the guide of the socket in the plugged-in state of the plug-in pin is quasi closed by the sleeve and the plug-in pin is thereby held centrally, namely centred by the sleeve.

Since the sleeve is firmly attached to this end of the plug-in pin, which from the point of view of the particular tool is the proximal end, the plug-in pin is thus held and secured in its locking position by the sleeve not only axially, but also radially. At the same time, the guide is closed and sealed against the ingress of contaminants, such as dust or moisture, by the sleeve, which is made, for example, of rubber or another energy-elastic material.

In accordance with the invention, the tool is either an electrically operable implement, such as a hedge trimmer, a lawn trimmer, a saw, a pair of shears, in particular pruning shears, or a non-electrical implement, such as a rake, a spade, a broom or a shovel.

In an aspect, there is provided a handling device for a processing device and/or a gardening and/or household device according to the statements above, wherein the handling device is provided with a handle portion and a connecting portion and also with an electrical power supply, wherein the connecting portion has means with which both an electrical and alternatively a non-electrical tool can be connected to the handling device and a mechanical and electrical connection of an electrical tool to the handling device is established, in particular simultaneously or quasi-simultaneously.

In another aspect, there is provided a connecting portion for a handling device according to the above statements and for a processing device, in particular a gardening and/or household implement, according to the above statements, wherein the connecting portion has means with which both an electrical and alternatively a non-electrical tool can be connected to the handling device and assembled to form a processing implement, in particular a gardening and/or household implement.

In another aspect, there is provided a connecting portion according to the above statements to connect both an electrical tool and, alternatively, a non-electrical tool to the handling device according to the above statements.

In summary, depending on whether the tools/implements are electrical or non-electric, there are different interfaces/handles for the different applications. In most cases of electrical tools, there are different handles with integrated technical components for each application and only the battery needs to be replaced in order to use them.

The disclosure herein offers the possibility of using an interface with an integrated power supply/battery that can be combined with various electrical and non-electrical tools without having to worry about which handle is necessary for which tool.

According to the previous prior art, a mechanical connection for the drive of the particular tool is always used to connect mechanical implements, and therefore it was not possible previously to connect electrical and non-electrical tools to one handling device and use them with it.

Compared to such a previous mechanical connection solution, the present disclosure has the advantage that it uses the best arrangement of components for each implement that can be connected, with a corresponding electric motor always being located in the tool used and being supplied with electrical energy via the handling device. Hereby, it is possible to minimise a power loss during a power transfer from a handle or a handling device to a tool, as an electrical interface allows a lower power loss than a mechanical connection with a shaft.

Furthermore, the disclosed processing device not only creates the possibility of using electrical and non-electrical tools, but also of changing them quickly and easily due to the use of the plug-in/detent and/or snap-fit connection in the form of a quick coupling or click connection.

The same connecting portion of the handling device is used to connect electrical and non-electrical tools. The provision of different interfaces and/or handles, as was previously necessary in the prior art, can thus be advantageously avoided.

### BRIEF DESCRIPTION OF DRAWINGS

In the following, the invention is described by means of exemplary embodiments, which are explained in more detail with reference to the figures, in which:

FIG. 1 shows a schematic representation of a processing implement;

FIG. 2 shows a schematic representation of a further processing implement;

FIG. 3 shows a schematic representation of an exemplary embodiment of a handling device;

FIG. 4 shows a sectional view along the line Z-Z of the exemplary embodiment shown in FIGS. 3; and

FIG. 5 shows an enlarged representation of the area of the handling device enclosed by a circle in FIG. 4.

### DETAILED DESCRIPTION OF THE INVENTION

In the following description, the same reference signs are used for identical and similarly acting parts.

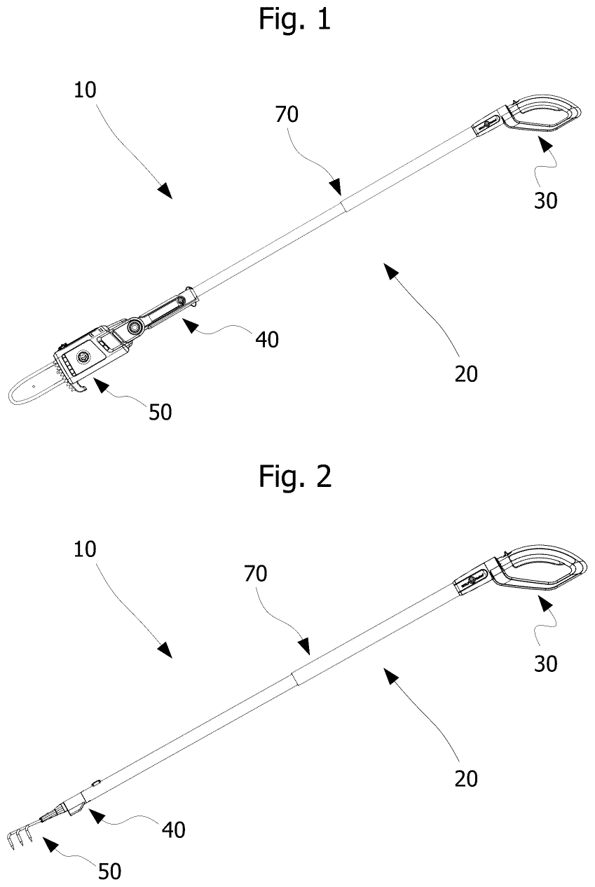

FIG. 1 shows a schematic representation of a processing device 10 in a perspective view. The processing device 10 comprises a handling device 20 with a tool 50 attached thereto. The handling device 20 in turn consists of a handle portion 30, which in turn comprises operating elements such as a safety button and a switching lever, and also a connecting portion 40. The connecting portion 40 is arranged at a distal end of an extension means 70 with respect to the handle portion 30. The connecting portion 40 serves both for the mechanical and the electrical connection of the tool 50 connected to the handling device 20 according to FIG. 1, namely an electrically operated saw.

FIG. 2 shows a schematic representation of a further processing device 10, wherein the processing device 10 is again in the form of a handling device 20 with a handle portion 30. According to FIG. 2, the handling device 20 is provided with an extension means 70 which, as in FIG. 1, can be telescopically extended or shortened. At the distal end of the extension means 70 with respect to the handle portion 30, a mechanical tool is arranged on the connecting portion 40 of the handling device 20. According to FIG. 2, the mechanical tool is a non-electrical tool in the form of a rake, or a claw or a cultivator, the claw being inserted with its plug-in pin into the connecting portion 40 of the handling device 20 and being locked therein, while the electrical contacts of the connecting portion 40 are not occupied.

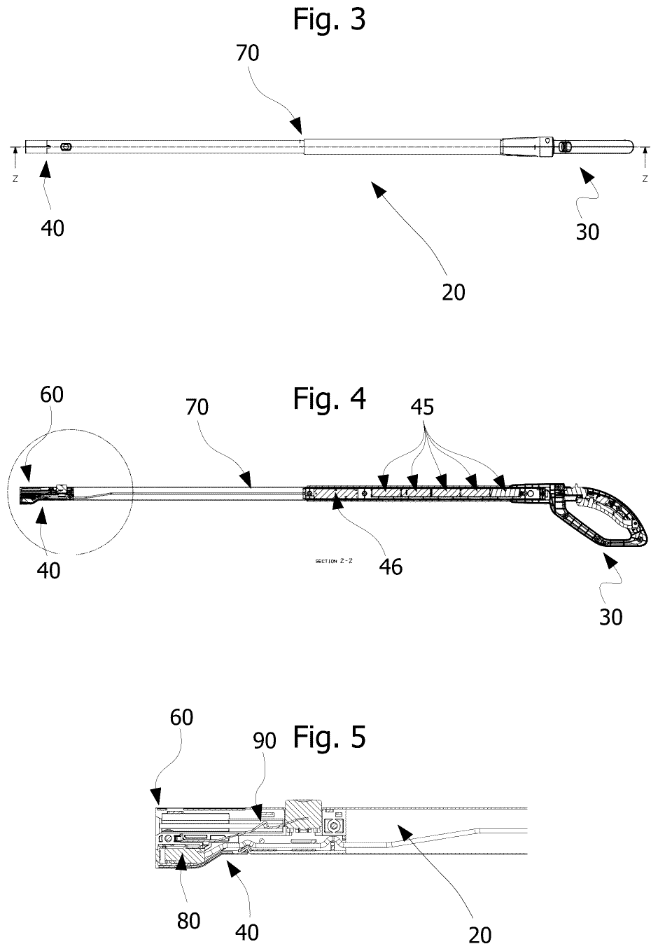

FIG. 3 shows a schematic representation of an exemplary embodiment of a handling device 20. The handling device 20 comprises a handle portion 30, on which operating elements of the processing implement 10 are arranged. An extension means 70 extends from the handle portion 30 in the direction of the connecting portion 40 and can be extended or shortened telescopically.

FIG. 4 shows a sectional view along the line Z-Z of the exemplary embodiment shown in FIG. 3, wherein it can be seen that a power supply 45 in the form of rechargeable batteries, or accumulators, as well as a control unit for controlling a connected electrical tool are arranged within the extension means 70. As can be further seen in FIG. 4, the connecting portion 40 is formed by a socket 60 which, as shown in more detail in FIG. 5, comprises both an electrical contact-making means 80 and a mechanical detent connection 90.

### LIST OF REFERENCE SIGNS

10 processing implement
20 handling device
30 handle portion
40 connecting portion
45 power supply
46 control unit
50 tool
60 socket
70 extension means
80 electrical contact-making means
90 mechanical detent connection

We claim:

1. A processing device (10), in particular a gardening and/or household device, comprising:
a handling device (20) comprising a gripping portion (30) and a connecting portion (40);
an electrical power supply (45); and
a tool (50) which can be detachably connected to the connecting portion (40) of the handling device (20),
wherein the tool (50) is an electrical or non-electrical tool and the connecting portion (40) is configured such that either of the electrical and the non-electrical tool (50) can be coupled to the handling device (20).

2. The processing device according to claim 1, wherein the connection portion (40) is in the form of a socket (60) and means for connecting either of the electrical and the non-electrical tool (50) to the handling device (20) are located within the socket (60).

3. The processing device according to claim 1, wherein the connecting portion (40) for mechanically connecting the tool (50) to the handling device (20) has detachable form-fit and/or frictional engagement means, for example in the form of a plug-in and/or clamping and/or screw and/or detent and/or snap-fit connection to a, preferably non-circular, guide, in order to insert a plug-in pin of the tool (50) into the connecting portion (40) and to lock it detachably in a locking position, in particular, in an end position.

4. The processing device according to claim 1, wherein the connecting portion (40) for the electrical connection of the tool (50) to the handling device (20) has at least two, preferably at least three, electrical contacts, for example in the form of sockets, in order to establish contact, in particular electrically conductive contact, with corresponding contacts, in particular plugs, of the tool (50).

5. The processing device according to claim 4, wherein the means for mechanical and electrical connection of the tool (50) to the handling device (20) are arranged relative to one another in such a way that, in the locking position of the mechanical connection, an electrical connection of the sockets to the corresponding plugs of the tool (50) is ensured.

6. The processing device according to claim 1, wherein the handling device (20) has, between the handle portion (30) and the connecting portion (40), an extension means (70), for example in the form of a tube extension or a shaft, which is in particular telescopic and optionally detachable from the handle portion (30) and/or connecting portion (40).

7. The processing device according to claim 6, wherein the electrical power supply (45), which is preferably at least one battery, optionally a rechargeable battery, is arranged in the extension means (70), optionally removably.

8. The processing device according to claim 7, wherein the socket (60) and/or the guide and/or the plug sockets has/have in each case at least one sealing lip and/or at least one scraper.

9. The processing device according to claim 8, wherein the guide is in the form of a sleeve which guides and/or holds the plug-in pin of the tool (50) closely and without play when it is inserted and/or in its locking position in the connecting portion (40).

10. The processing device according to claim 1, wherein the tool (50) is an electrically operable implement, such as a hedge trimmer, a lawn trimmer, a saw, a pair of shears, in particular pruning shears, or a non-electrical implement, such as a rake, a spade, a broom or a shovel.

11. A handling device (20) for a processing device, in particular a gardening and/or household device, according to any one of the preceding claims, having a handle portion (30) and a connecting portion (40) and an electrical power supply (45), wherein the connecting portion (40) has means with which either of an electrical and a non-electrical tool (50) can be connected to the handling device (20).

12. The handling device according to claim 11, wherein the means for mechanical and electrical connection of the electrical tool (50) to the handling device (20) are arranged relative to one another in such a way that simultaneous or quasi-simultaneous mechanical and electrical connection of the tool (50) to the handling device (20) is established.

13. The handling device according to claim 12, further comprising a processing device (10), in particular a gardening and/or household device, wherein the connecting portion (40) has means with which both an electrical and alternatively a non-electrical tool (50) can be connected to the handling device (20) and assembled to form a processing device (10), in particular a gardening and/or household implement.
